(19) United States
(12) Patent Application Publication
(10) Pub. No.: US 2011/0209131 A1
(43) Pub. Date: Aug. 25, 2011

(54) METHOD AND DEVICE FOR REPLACING A COMPONENT OF A COMPUTER SYSTEM

(76) Inventors: Uwe Hohenstein, Vaterstetten (DE); Michael Jäger, Munchen (DE)

(21) Appl. No.: 13/122,507

(22) PCT Filed: Aug. 27, 2009
(86) PCT No.: PCT/EP09/61046

§ 371 Date: Apr. 6, 2011

(30) Foreign Application Priority Data
Oct. 6, 2008 (DE) 10 2008 050 568.4
Dec. 10, 2008 (DE) 10 2008 061 480.7

(51) Int. Cl. G06F 9/44

(52) U.S. Cl. 717/168

(57) ABSTRACT

Within a migration process of a computer system, a replacement component (1) of a computer system is replaced with a substitute component (2), wherein the substitute component (2) forms an alternative component to the component (1) requiring to be replaced and being of the same kind as the component (1) requiring to be replaced. The method according has the steps:—Determining of the replacement component (1) and of the substitute component (2);—Implementing (S2) modifications to the substitute component (2) by aspect programming in a so called aspect (4a) wherein the implementing is based on determined differences in functionalities;—Translating (S3) the aspect (4a) and generating a library (5a) containing the translated aspect; and—Applying (S4) the aspect (4a) to the substitute component (2) available as the translated library. A flexible execution of the migration within a computer system can thereby be effected.

### CROSS-REFERENCE TO RELATED APPLICATIONS

This application is a U.S. National Stage Application of International Application No. PCT/EP2009/061046 filed Aug. 27, 2009, which designates the United States of America, and claims priority to German Application No. 10 2008 050 568.4 filed Oct. 6, 2008 and German Application No. 10 2008 061 480.7 filed Dec. 10, 2008. The contents of which are hereby incorporated by reference in their entirety.

### TECHNICAL FIELD

The present invention relates to replacing a replacement component of a computer system with a substitute component as part of a migration process in the computer system.

### BACKGROUND

The term “migration” refers to the replacement of a constituent part of a computer system with an equivalent substitute. The part being substituted is in the following called the replacement component of migration. The part taking the replacement component's place is called the substitute component of migration. The overall system affected by migration is the migration system.

Both software components and hardware components can generally be replaced or, as the case may be, substituted through migration using corresponding software components and/or hardware components. What are considered in the following within the scope of migration are substitute components based on software, which is to say software components as such and hardware components whose operation is software-based. What is in both cases considered and dealt with below is the software side during the performance of migration.

It must therein be made clear that migration primarily does not mean refashioning a system's architecture or producing a previously absent autonomous constituent part. Rather it is the case that the replacement and substitute component of migration are the same kind of elements or, as the case may be, components. The processes comprising a migration would otherwise have to be referred to in summary as restructuring, refactorizing, reengineering etc., for which other processes and other objectives form the basis, however.

A typical application for a migration is the substituting of a constituent part by a corrected, alternative, better, or newer version. For example a database system of employee-administration software can be substituted by a more up-to-date version of the database system. The term “migration” refers in that case to a completed process that comprises the possibly necessary backing up and transferring of data and configuring and testing the migration and the migration system.

Another known instance of a migration is the installation of a new version of an operating system into a computer system. The replacement and substitute component of migration (old and new version of the operating system) are of the same kind here, too. A certain effort in terms of planning and configuring and also of testing the migration can nonetheless be expected so that migrating constitutes an autonomous activity that can be structured.

A migration's extent depends on the differences between the replacement component and substitute component. Even though the replacement component and substitute component are of the same kind, the functionality provided by the replacement component can still differ in detail from that provided by the substitute component so that the substitute component will require matching.

The aim therein is to ensure that the migration system will behave the same way on completion of migration as before migration. Matching can therein be performed either on the substitute component in order thereby to establish the same relevant characteristics of the overall system as were present at the outset, which is to say before migrating took place, or on the migration system if the differences between the replacement component and substitute component cannot be compensated by matching the substitute component. The intention in both cases is to establish compatibility between the substitute component and migration system to a degree that existed between the replacement component and migration system prior to migration.

Migration scenarios and the application of migrating are generally attracting greater attention these days. That is due in particular to an increasing use of other manufacturers' software such as, for example, databases, object-relational (O/R) frameworks, Java Platform, Enterprise Edition (JEE) application servers, Open Services Gateway initiative (OSGi) containers.

In the event of problems, a lack of functionality, or a poor price/performance ratio, migrating will as a rule provide a means of overcoming those drawbacks. It is, moreover, a feature of today's information technology (IT) landscape that existing software solutions are more likely to be further developed than new ones created and that there is a large market for consultancy services for migrations of such kind.

Depending on the initial situation, the following basic instances can be distinguished in terms of performing a migration using known methods or procedures:

1. If the substitute component's source code or, as the case may be, software code is unavailable, it will not be technically possible to extend the substitute component's internal functionality.

2. If the substitute component's source code or, as the case may be, software code and the translating instructions (“build scripts”) for the source code or, as the case may be, software code are available, it will be possible to modify the source code and retranslate it. Modifying and retranslating are processes that are relatively easy to perform.

3. If the substitute component's source code or, as the case may be, software code is available but there are no instructions for translating the source code or, as the case may be, software code, then the translating process for the substitute component's source code or, as the case may be, software code will have to be reconfigured, which is associated with substantial additional effort.

Alongside the technical requirements there are further aspects to take into account:

a) Licensing conditions that usually apply mean that a substitute component cannot be modified or retranslated unless additional conditions are accepted. A widespread instance of conditions of said kind is the disclosure of the modifications. That may in many cases not be desired because of the associated expertise disclosure. Other conditions can be, for example, repercussions for the licensing terms and conditions applying to the entire migration system, which may possibly alter the business model.

b) While modifying and retranslating are indeed technically possible, they would mean ceasing to be licensed because modifications are not permitted by the licenser.

c) Modifying and retranslating the substitute component are to be regarded as unrestricted.

It is apparent from the above list that only a combination of above items 2 and c) and, in part, also of above items 2 and a) can be deemed to be resolvable and reasonable situations for migrating on account of the technically possible translation capability and the framework conditions corresponding to the technically possible translation capability.

For the other instances there is as yet no method having general validity and capable of being applied systematically. Depending on the specific application there may be approaches that do not guarantee that migration will be performed successfully. For example the substitute component can be encapsulated for providing additional functionality. However, that will only work for externally available interfaces. No suitable solution can be provided in that way for handling differences that affect the internal operational sequences.

Apart from the instances that can clearly be resolved, it is apparent that owing to a lack of systematically designed approaches there will be a high probability of the migration's failing if the other above-cited items are combined. Not inconsiderable disadvantages are the result. For example the substitute component's lack of functionality will generally not be recognized until later despite thorough analysis and planning. The migration's failure and termination will then perforce mean that a wrong investment has been made and require another investment using an alternative substitute component.

Notwithstanding the above-cited problems, migration is, though, the means of choice when it comes to improving performance, increasing efficiency, and further developing and/or matching computing systems, components, devices, modules, and/or applications.

### SUMMARY

According to various embodiments, an improved method for migrating a component of a calculating system, in particular a computer system can be provided.

According to an embodiment, a method for replacing a replacement component of a computer system with a substitute component, with the replacement component in the computer system being substituted by the substitute component, with the substitute component forming an alternative component to the component requiring to be replaced and being of the same kind as the component requiring to be replaced, may comprise:
Implementing modifications to the substitute component by means of aspect programming in an aspect based on ascertained differences in functionality between the replacement component and substitute component;
Translating the aspect and generating a library containing the translated aspect; and
Applying the aspect to the substitute component available as the translated library.

According to a further embodiment, the aspect can be implemented separately from the substitute component. According to a further embodiment, applying the aspect to the substitute component available as a translated library may include creating a new library of the substitute component. According to a further embodiment, the method may include establishing the location of the aspect in the substitute component. According to a further embodiment, applying the aspect to the substitute component available as a translated library can be performed using the aspect at the established location in the substitute component. According to a further embodiment, what is established by the location can be which code of the substitute component is to be modified.

According to another embodiment, an arrangement for replacing a replacement component of a computer system with a substitute component, with the replacement component in the computer system being substituted by the substitute component, with the substitute component forming an alternative component to the component requiring to be replaced and being of the same kind as the component requiring to be replaced, may comprise:
A function-analyzing device for ascertaining differences in functionality between the replacement component and substitute component;
A matching device for implementing modifications to the substitute component by means of aspect programming in an aspect, with implementing being based on the ascertained differences in functionality;
A translation device for translating the aspect and generating a library containing the translated aspect; and
An application device for applying the aspect to the substitute component available as a translated library.

According to yet another embodiment, a computer-program product may execute a method as described above on a computer system.

### BRIEF DESCRIPTION OF THE DRAWINGS

Various embodiments are described in detail in the following with reference to the figures attached below.

FIG. 1 is a flowchart showing the steps of the method for replacing a replacement component of a computer system with a substitute component according to an exemplary embodiment; and

FIG. 2 is a schematic of an arrangement for replacing a component of a computer system according to an exemplary embodiment.

### DETAILED DESCRIPTION

As already mentioned, the aforementioned object is achieved by means of a method for replacing a replacement component of a computer system with a substitute component, with the replacement component in the computer system being substituted by the substitute component, with the substitute component constituting an alternative component to the component requiring to be replaced and being of the same kind as the component requiring to be replaced, and with the method including:
Implementing modifications to the substitute component by means of aspect programming in an aspect based on ascertained differences in functionality between the replacement component and substitute component;
Translating the aspect and generating a library containing the translated aspect; and
Applying the aspect to the substitute component available as the translated library.

The replacement component and substitute component each constitute a software component that is provided and configured for applying to and using in a computer system. The replacement component and substitute component therein assume various functions of the computer system. For example the replacement component and substitute component can assume the functions of driving, controlling, and/or administering other components of the computer system. Said other components can therein be software and/or hardware components.

It should further be noted that according to the present invention the term “library” is to be understood as a program library or software library which in software programming refers to a collection of program or software functions for tasks that belong together as illustrated above.

An efficient, effective, and flexibly structurable way of implementing migration is made possible by various embodiments. In particular, explicit matching of the substitute component's source code is therein unnecessary. That means various embodiments can be implemented even if no source code is available. The above-explained framework problems can also be obviated thanks to various embodiments. Using the method according to various embodiments will additionally prevent errors in the substitute component's original code from sneaking in and also render expensive testing and validating of the substitute component and migration system unnecessary. Performing a migration according to various embodiments will make the implemented modifications' maintainability clear and also significantly more easily, effectively, and efficiently manageable.

According to an exemplary embodiment, the aspect is implemented separately from the substitute component. The aforementioned problems will in that way be prevented from arising. The modifications are furthermore clearly separated from the substitute component, a consequence of which is better handling and improved testing of a migration's success.

According to an exemplary embodiment, applying the aspect to the substitute component available as a translated library has the outcome of creating a new and expanded library of the substitute component. The manner in which the substitute component is compiled will in that way remain unchanged, a particular advantage of which is that the aforementioned problems can be obviated.

According to another exemplary embodiment, the method has a step of establishing the location of the aspect in the substitute component. That will make selective modifying or matching possible, with at the same time no intervention being required in the substitute component or, as the case may be, its code or library. According to an exemplary embodiment, applying the aspect to the substitute component available as a translated library is therein performed using the aspect at the established location in the substitute component.

According to an exemplary embodiment, what is established by the location is which code or, as the case may be, which part of the code of the substitute component is to be modified. That will enable very precise and very selective modifying or matching of the substitute component or, as the case may be, its software code, or, as the case may be, its library that is performed at the code level and which at the same time will leave the substitute component unchanged.

The various embodiments described here use the deployment of aspect-oriented programming (AOP) for compensating shortcomings in a substitute component's functionality and establishing the necessary compatibility between the migration system and substitute component. The functionality expansions or, as the case may be, modifications are for that purpose defined separately from the substitute component in what is termed an aspect. A constituent part of that definition is also establishing at what location in the substitute component the aspect is to be applied. The fundamental scheme therein is that the substitute component is available as an already translated library (for example as a Java archive “.jar” within the sphere of the programming language Java), remains unchanged, and is modified using separately present aspect definitions.

The method for applying an aspect as well as the aspect definition's syntax depend on the implementation employed. Implementations are currently available for practically all customary programming languages for the application of AOP.

In Java programming, for example, an aspect can be implemented as a standard Java class. The class describes the expanded or modified functionality. Annotations indicate which code sections of the substitute component are to be replaced or expanded. A specific method establishes how an expanded substitute component can be produced.

The present invention is not therein limited just to Java programming. The aspects can according to various embodiments be implemented in different programming languages. Nor is the present invention limited just to implementing by means of a Java class; rather it is the case that different suitable programming paradigms can be used.

A method for eliminating differences in functionality during migrating using AOP is provided by various embodiments. AOP has hitherto be used only for the structured redevelopment of applications. The various embodiments use of AOP lies in its application to already existing components supplied by third-party manufacturers. The classical role model—the developer of the component also defines associated aspects—is eliminated thereby. Producing the component and defining the associated aspects are according to various embodiments carried out by different parties.

As indicated above, a particular advantage of various embodiments is that no explicit source-code matching is necessary. According to various embodiments an external description of the modifications is produced as an aspect available separately from the substitute component. The consequent advantage is that it is unnecessary for the substitute component's source code to be available.

According to various embodiments, no knowledge of or familiarity with configuring the translation process (the “build script”, for example) is needed because the new translation of the substitute component is dispensed with.

Furthermore, the existing and originally created source code or, as the case may be, the translated source code or the manner in which the substitute component is compiled remains unchanged.

In contrast to component encapsulating that constitutes a customary procedure in the prior art, changes can be made to the internal functionality by various embodiments. The known methods that implement encapsulating of the component employ, for example, what are called wrappers that are embodied for translating one interface into another to enable classes to communicate using mutually incompatible interfaces. Although the internal functionality cannot be changed with said known methods, it is of significance particularly when it is necessary to extract internal processing information not offered over the interfaces by the substitute component. The various embodiments thus offer a much more powerful method providing far more possibilities of functional expansion in a substitute component.

Formulating a functional expansion in an external aspect will furthermore allow the modifications to be separated from the substitute component's original embodiment. The modification's traceability and maintainability will be enhanced thereby. Were the substitute component's source code to be modified, either a method for marking the modification or a method for making a comparison with the original would have to be provided to ensure traceability.

The various embodiments thus offers a development framework by means of which functionality expansions can be incorporated in the substitute components available as existing libraries.

The method according to various embodiments allows migrating or, as the case may be, replacing of a computer system's replacement component with a substitute component to be performed securely, effectively, and comprehensively. The result is a secure and effective improvement in performance, enhanced efficiency, and matching of the computer system in which the substitute component is used.

As described above, it does not as a rule just stop at adaptations in the case of computer systems that are migration systems. Rather it is the case that the adaptation also has to be integrated. Tests furthermore have to be carried out to verify that the migration system and substitute component are compatible. Migrating can overall be divided into the following phases:

1. Planning, which includes selecting a substitute component and ascertaining the differences between the replacement and substitute component.

2. Bridging a lack of functionality, which also includes implementing necessary matching in the substitute component or migration system.

3. Integrating the substitute component, with it as a rule being necessary to use other classes or, as the case may be, their interfaces with other methods in order to link up the substitute component or, as the case may be, integrate it into the migration system. That can mean an increased expenditure if there are major syntactic differences.

4. Testing the migration result.

The various embodiments relate therein particularly to phase 2 of migration, which is to say bridging the substitute component's lack of functionality and implementing necessary matching in the substitute component. The fundamental case is that modifications have to be performed on the substitute component to achieve the original compatibility. That is required when the substitute component fails to make a functionality available that was present in the replacement component. The critical point of migration can also be found there. The entire migration project will fail if it proves not to be possible to establish the necessary compatibility in the conventional manner. A further aggravating factor is that shortcomings of such kind in the substitute component are not recognized until much later.

The various embodiments presented here enable the substitute component to be modified to make compatibility with the migration system possible. It is an approach that also for the first time offers a solution in the event that the substitute component's source code cannot be modified owing to legal framework conditions.

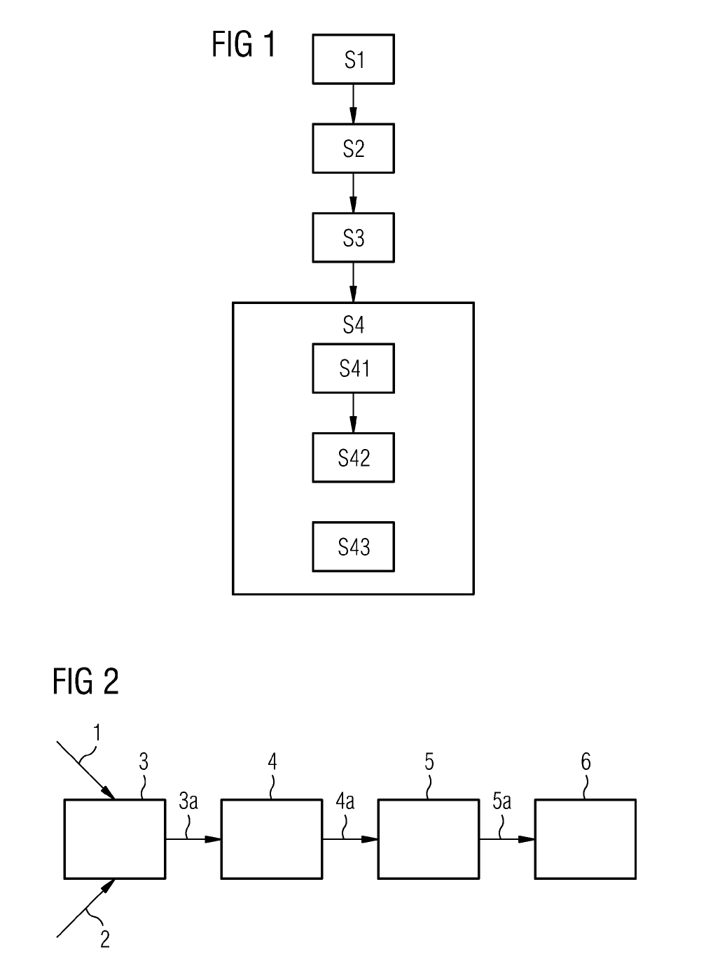

FIG. 1 is a flowchart showing the replacement of a replacement component of a computer system with a substitute component according to an exemplary embodiment.

Differences, in particular differences in functionality between the replacement component and substitute component are ascertained at a step S1. The ascertained differences in functionality are used for modifying or, as the case may be, matching the substitute component at step S2 by means of aspect programming in what is termed an aspect.

The implemented aspect is then translated at step S3, with a library containing the translated aspect also being generated. The translated aspect, in particular the library containing the translated aspect, is then applied to the substitute component at step S4. The substitute component is therein available as a translated library.

Applying the aspect to the substitute component at step S4 can include establishing the aspect's location in the substitute component. That is performed at step S41 according to the present exemplary embodiment. If such kind of location of the aspect is determined, then applying S4 the aspect to the substitute component includes using the aspect at the established location. That is performed at step S42. What is established by the location is which code of the substitute component is to be modified or, as the case may be, matched.

Furthermore, when the aspect is applied S4 to the substitute component, a new library of the substitute component is created that is a library expanded to include the aspect. The creation of the expanded library is represented in FIG. 1 by step S43.

FIG. 2 is a schematic representation of an arrangement for replacing a component of a computer system according to an exemplary embodiment.

A replacement component 1 and substitute component 2 are made available. Replacement component 1 is to be replaced by substitute component 2. A function-analyzing device 3 analyzes in each case the functionality made available by replacement component 1 or, as the case may be, substitute component 2. The ascertained difference in functionality 3a is conveyed to a matching device 4. Matching of the functionality of substitute component 2 to the functionality of replacement component 1 is implemented in matching device 4 as an aspect 4a. Implemented aspect 4a is conveyed to a translation device 5. Translation device 5 is an aspect library 5a having aspect 4a. Aspect library 5a is conveyed to an application device 6. Application device 6 applies aspect library 5a to substitute component 2, with substitute component 2 being available as a library.

The functionality of substitute component 2 has thereby been matched to the functionality of replacement component 1. Replacement component 1 can consequently be replaced by substitute component 2.

Various embodiments are explained in the following by way of example with the aid of a project in which the method is successfully implemented.

The object-relational framework “Hibernate” is therein used in a software system to facilitate access to a relational database. Owing to a particular framework condition, the framework “Hibernate” must in the example shown be detached from the software system and substituted by an alternative product. Migrating consists in substituting another object-relational framework called “OpenJPA” for “Hibernate”. Hence the replacement component of said migration is “Hibernate” and the substitute component is “OpenJPA”.

Viewed superficially it is a clear migration project because the replacement component and substitute component have a comparable functionality. In principle only different interfaces have to be used in the migration system, it being possible to manage that using encapsulating, as explained above.

However, an in-depth examination points up the following serious problems:

1. To ensure the database's fail-safe performance, a special failover database URL jdbc:solid://<host1>:<port1>,<host2>:<port2>/<usr>/<password> is used that establishes a primary and secondary computer host1 and host2 respectively. In the event of an outage of the database system on the primary computer, for example because the computer has powered down, then automatic switchover will take place to the secondary computer on standby which will immediately assume database operation. However, that special database fail-safe facility worked under “Hibernate” but does not work under “OpenJPA”. That is because the failover URL type of “OpenJPA” is not admitted. The correct URL jdbc:solid://<host1>:<port1>,<host2>:<port2>/<usr>/<password> is truncated to jdbc:solid://<host1>:<port1>. The result of that incorrect treatment of the URL by “OpenJPA” is that a connection setup to the SOLID database is no longer possible at all. In the event of a <host1> outage there will in particular no longer be an automatic changeover to <host2>, although it is absolutely necessary.

2. In addition to the database URL, a special option solid_tf_level has to be set to 11 to enable failover to take place. “OpenJPA” does not, though, offer the option of setting a corresponding property and passing it on to the database system.

Those problems are critical to the overall success of the migration. Not resolving them will condemn migrating from “Hibernate” to “OpenJPA” or, as the case may be, substituting “OpenJPA” for the object-relational framework “Hibernate” to failure. The effort hitherto expended on the project will then likewise have been in vain. Selecting another, new candidate as a substitute component then migrating using said new candidate will result in a further expenditure of effort amounting to several person months—with no foreseeable prospect of success.

The above-discussed conventional approaches, such as encapsulating or source-code modifications, do not offer any adequate solutions because, for example, the source code is not available through them so cannot be modified.

Successful migrating can, though, be achieved by means of various embodiments as explained in this exemplary embodiment.

Aforementioned problems 1 and 2 are resolved according to the present exemplary embodiment using the following schematically represented aspect:

```
@Aspect
public class ChangeURLAspect {
@Around(“execution(“public static * ”
+ “ org..Configurations.parseProperties(String)) ”
+ “&& args(str) && within(org.apache.openjpa.lib.conf..*)”)
// Configurations.parseProperties contains the error: URL
// is torn apart: The following replacement method
// will correct that:
public Object parseProperties(final String str, final Join-
Point jp) {
  Options opts = new Options( );
  String properties = StringUtils.trimToNull(str);
  if (properties == null) {
    return opts;
  }
  try {
    String [ ] props = Strings.split(properties, ”, ”, 0);
    int idx;
    char quote;
    String prop;
    String val;
    for (int i = 0; i < props.length; i++) {
      idx = props[i].indexOf (‘=’);
      // The original behavior: If a part does not contain
      // “=” it will be ignored
      if (idx == −1) {
        prop = props[i];
        val = prop;
        // The following part corrects the
        // original behavior
        int colon = prop.indexOf(“:”);
        int slash = prop.indexOf(“/”);
        if (colon > 0 && slash > 0) {
          // Failover URL recognized
          final String host = prop.substring(0, colon);
          final String ip = prop.substring(colon + 1,
slash) ;
          int slash2 = prop.indexOf(“/”, slash + 1);
          final String usr = prop.substring(slash + 1,
slash2);
          final String pw = prop.substring(slash2);
          // Expand URL again with ignored part:
          opts.put(“URL”,
            opts. get (“Url”) + “,” + host + “:” + ip +
“/” + usr + pw);
        }
      } else {
        prop = props[i].substring(0, idx).trim( );
        val = props[i].substring(idx + 1).trim ( );
      }
      ...
      opts.put(prop, val);
    }
    return opts;
  } catch (RuntimeException re) {
    throw new ParseException(re);
  }
}
@Before(“execution(* solid.jdbc.SolidDriver.connect(..))”
      + “&& within(solid.jdbc.*)”)
// solid_tf_level = 1 is still co-supplied to the Properties
// object transferred to the method SolidDriver.connect
public void addSolidTfLevel (final JoinPoint jp) throws Throw-
able {
  Object[ ] args = jp.getArgs ( );
  if (args != null && args.length > 1
      && args[0].getClass( ).equals(String.class)
      && args[0].toString( ).toLowerCase( ).contains(“solid”)
      //-> only for Solid-DB
      && args[1].getClass( ).equals(Properties.class)) {
        // -> set Property
        ((Properties) args[1]).setProperty(“solid_tf_level”,
“1”);
      }
    }
}
```

A brief explanation of the software code shown above is given below.

The aspect ChangeURLAspect is a Java class that becomes an aspect through an @Aspect annotation.

The Java annotation @Around replaces the code present in the substitute component. The annotation @Before executes the code prior to the execution. The character string inside the annotation in each case establishes which code is affected:

a) execution(“public static* org..Configuraitons.parseProperties(String)):
The execution of a static method parseProperties of a Configurations class with a string parameter and any return value (*)

b) execution(*solid.jdbc.SolidDriver.connect(..)):
The execution of a connect method of the SolidDriver class with any parameters and return value

In the present exemplary embodiment the method of aspect ChangeURLAspect, which method is annotated with @Around and will clear the problem, is executed instead of the original method parseProperties that has faults.

The property solid_tf_level is furthermore set prior to the execution of the SolidDriver.connect method in the ChangeURLAspect method addSolidTfLevel

Instructions are furthermore necessary for creating a substitute library. In the present exemplary embodiment they are presented by way of example and in extract form as build.xml for the build tool ANT:

The following steps are for that purpose coded in the build.xml file:

1. Translating the above aspect

```
<!-- 1. General translation of the aspects -->
<target name = “compile”>
  <mkdir dir = “classesaspect”/>
  <javac srcdir = “aspects” destdir = “classesaspect”>
    <classpath refid = “project.classpath”/>
  </javac>
</target>
<taskdef name = “iajc”
    classname = “org.aspectj.tools.ant.taskdefs.AjcTask”
    classpath = “$(repository)/aspectj/jars/aspectjtools
1.5.0.jar”/>
```

2. Creating a library libaspecturl.jar containing the translated aspect.

```
  <!-- 2. Building a library containing aspects -->
  <target name = “buildaspectlib” description = “Compile as-
pect and build library”
    depends = “ compile”>
  <iajc outjar = “lib-aspecturl.jar”
      XnoWeave = “true” source = “1.5”>
    <classpath refid = “projectclasspath”/>
    <sourceroots location = “aspects/url”/>
  </iajc>
</target>
```

3. Application of the aspect to the libraries requiring to be changed openjpa-0.9.7-incubating.jar and soliddriver-4.5.127.jar and generating new new- . . . -variants of the substitute component's libraries. In the present example those are new-openjpa-0.9.7.jar and new-soliddriver4.5.127.jar.

```
  <!-3. Apply the aspect to openjpa-0.9.7-incubating.jar and
    soliddriver-4.5.127.jar -->
  <target name = “producelibs” depends = “buildaspectlib”
      description = “Enhance Java classes for patching
OpenJPA”>
    <iajc outjar = “new-openjpa-0.9.7.jar”>
      <classpath refid = “project.classpath”/>
      <incjars>
<pathelement location = “openjpa-0.9.7-incubating.jar”/>
<pathelement location = “libaspecturl.jar”/>
</injars>
  <aspectpath>
    <pathelement location = “libaspecturl.jar”/>
  </aspectpath>
    </iajc>
    <iajc outjar = “new-soliddriver-4.5.127.jar”>
    <classpath refid = “project.classpath”/>
    <injars>
      <pathelement location = “soliddriver-4.5.127.jar”/>
      <pathelement location = “libaspecturl.jar”/>
    </injars>
    <aspectpath>
      <pathelement location = “libaspecturl.jar”/>
    </aspectpath>
      </iajc>
</target>
```

A replacement component will thus be replaced, in the present exemplary embodiment, with the support that is lacking in the case of “OpenJPA” for the database's fail-safe performance and the availability of services that are in progress as well as of data being ensured according to the proposed method. What is therein advantageous is that the proposed method will enable error-resilient migrating of components requiring to be replaced.

In particular, applying the aspect-oriented programming paradigm as well as employing libraries that can be linked in dynamically will enable flexible component migrating.

It is furthermore advantageous that the source code stored in the libraries can be reused.

The various embodiments thus relate to replacing a replacement component of a computer system with a substitute component as part of a migration process in the computer system, with the replacement component in the computer system being substituted by the substitute component and with the substitute component constituting an alternative to the component requiring to be replaced and being of the same kind as the component requiring to be replaced. The method according to various embodiments therein has the following steps: Ascertaining differences in functionality between the replacement component and substitute component; Implementing modifications to the substitute component by means of aspect programming in what is termed an aspect, with implementing being based on the ascertained differences in functionality; Translating the aspect and generating a library containing the translated aspect; and applying the aspect to the substitute component available as the translated library. Flexible performance of migrating in a computer system will be achieved thereby.

Although explained above with reference to the exemplary embodiments according to the attached drawings, it is evident that the invention is not limited thereto but can be modified within the scope of the inventive idea disclosed above and in the dependent claims. There can obviously be yet further exemplary embodiments that encompass the invention's fundamental principle and are equivalent so that various modifications can be implemented without departing from the invention's scope. Thus different programming languages can use different programming paradigms for implementing aspects according to the present invention. The present invention can furthermore be employed in different areas of application of a computer system that rely on using software to perform, for example, control, operational, administrative, and/or organization processes.

What is claimed is:

1. A method for replacing a replacement component of a computer system with a substitute component, with the substitute component forming an alternative component to the component requiring to be replaced and being of the same kind as the component requiring to be replaced, and with the method comprising:
Implementing modifications to the substitute component by means of aspect programming in an aspect based on ascertained differences in functionality between the replacement component and substitute component;
Translating the aspect and generating a library containing the translated aspect; and
Applying the aspect to the substitute component available as the translated library.

2. The method according to claim 1, wherein the aspect being implemented separately from the substitute component.

3. The method according to claim 1, wherein applying the aspect to the substitute component available as a translated library including includes creating a new library of the substitute component.

4. The method according to claim 1, further comprising establishing the location of the aspect in the substitute component.

5. The method according to claim 4, wherein applying the aspect to the substitute component available as a translated library is performed using the aspect at the established location in the substitute component.

6. The method according to claim 1, wherein what is established by the location is which code of the substitute component is to be modified.

7. An arrangement for replacing a replacement component of a computer system with a substitute component, with the substitute component forming an alternative component to the component requiring to be replaced and being of the same kind as the component requiring to be replaced, and with the arrangement comprising:
A function-analyzing device for ascertaining differences in functionality between the replacement component and substitute component;
A matching device for implementing modifications to the substitute component by means of aspect programming in an aspect, with implementing being based on the ascertained differences in functionality;
A translation device for translating the aspect and generating a library containing the translated aspect; and
An application device for applying the aspect to the substitute component available as a translated library.

8. (canceled)

9. The arrangement according to claim 7, wherein the aspect being implemented separately from the substitute component.

10. The arrangement according to claim 7, wherein the application device is operable to apply the aspect to the substitute component available as a translated library by creating a new library of the substitute component.

11. The arrangement according to claim 7 wherein the location of the aspect in the substitute component is established.

12. The arrangement according to claim 11, wherein the application device is operable to apply the aspect to the substitute component available as a translated library by using the aspect at the established location in the substitute component.

13. The arrangement according to claim 11, wherein what is established by the location is which code of the substitute component is to be modified.

14. A computer-program product comprising a computer readable medium storing instructions for replacing a replacement component of a computer system with a substitute component, with the substitute component forming an alternative component to the component requiring to be replaced and being of the same kind as the component requiring to be replaced, which instructions when executed on a computer system perform the steps of:
Implementing modifications to the substitute component by means of aspect programming in an aspect based on ascertained differences in functionality between the replacement component and substitute component;
Translating the aspect and generating a library containing the translated aspect; and
Applying the aspect to the substitute component available as the translated library.

15. The computer program product according to claim 14, wherein the aspect being implemented separately from the substitute component.

16. The computer program product according to claim 14, wherein applying the aspect to the substitute component available as a translated library includes creating a new library of the substitute component.

17. The computer program product according to claim 14, further comprising establishing the location of the aspect in the substitute component.

18. The computer program product according to claim 17, wherein applying the aspect to the substitute component available as a translated library is performed using the aspect at the established location in the substitute component.

19. The computer program product according to claim 14, wherein what is established by the location is which code of the substitute component is to be modified.
